(19) United States
(12) Patent Application Publication
(10) Pub. No.: US 2025/0291316 A1
(43) Pub. Date: Sep. 18, 2025

(54) LUNAR AND SOLAR ECLIPSE DISPLAY MECHANISM

(71) Applicant: the Swatch Group Research and Development Ltd., Marin (CH)

(72) Inventors: Michel WILLEMIN, Preles (CH); Gregory Kissling, La Neuveville (CH); Jean0Claude Martin, Moontmollin (CH)

(73) Assignee: The Switch Group Research and Development Ltd., Marin (CH)

(21) Appl. No.: 19/066,575

(22) Filed: Feb. 28, 2025

(30) Foreign Application Priority Data
Mar. 15, 2024 (EP) 24 163823.8

(51) Int. Cl. G04B 19/26

(52) U.S. Cl. CPC G04B 19/268

(57) ABSTRACT

A mechanism for displaying lunar and solar eclipses for a mechanical or electromechanical horological movement configured to be able to operate the mechanism. The mechanism (1) includes a first moving indicator (2) corresponding to a first luminary and a second moving indicator (3) corresponding to a second luminary. Provided is a first zone (6) in which the first indicator (2) and second indicator (3) are visible, and a second zone (7) allowing the one or more indicators (2, 3, 4, 5) to be concealed behind a cover (8). Also, a third moving indicator (4) corresponding to the second luminary in a configuration that is different from that of the second indicator (3), the third moving indicator (4) having at least one visible feature that is different from the second moving indicator (3), wherein the third indicator (4) is visible in the first zone (6) instead of the second indicator (3).

### CROSS REFERENCE TO RELATED APPLICATION

This application claims priority to European Patent Application No. 24163823.8 filed Mar. 15, 2024, the entire contents of which are incorporated herein by reference.

### TECHNICAL FIELD OF THE INVENTION

The present invention relates to a mechanism for displaying eclipses, in particular of the Moon and/or Sun, for a timepiece.

### TECHNOLOGICAL BACKGROUND

Moon phase display mechanisms have been known for a long time, both in purely mechanical mechanisms and in electromechanical mechanisms.

More sophisticated display mechanisms can even display other luminaries, in particular the Sun, so as to be able to determine when eclipses of the Moon and/or Sun occur.

For example, European patent EP0195742 shows a display with hands on which these luminaries are arranged. This mechanism can in particular be used to determine the occurrence of eclipses. However, it does not distinguish between different types of eclipse. Total or partial eclipses of the Moon or Sun occur, depending on where you are on Earth. Annular eclipses of the Sun also occur when the apparent diameter of the Moon is less than that of the Sun.

Patent documents CH715722 and WO2020/152015 show another type of display mechanism, which makes it possible to distinguish between a partial or total eclipse, or even to follow it in real time. However, this display mechanism is not easy to read or intuitive at first glance.

### SUMMARY OF THE INVENTION

The invention aims to provide an eclipse display mechanism that is easier to understand and with clearer visualisation for a user.

To this end, the invention relates to a mechanism for displaying lunar and solar eclipses for a mechanical or electromechanical horological movement configured to be able to operate said mechanism, the eclipse display mechanism comprising a first moving indicator corresponding to a first luminary, for example the Sun, and a second moving indicator corresponding to a second luminary, for example the Moon, the eclipse display mechanism comprising a first zone in which the first and second indicator are visible, and a second zone allowing the one or more indicators to be concealed behind a cover, the eclipse display mechanism comprising a third moving indicator corresponding to the second luminary in a configuration that is different from that of the second indicator, the third moving indicator having at least one visible feature that is different from the second moving indicator, the first indicator, the second indicator and the third indicator preferably being disc-shaped.

The invention is characterised in that the third indicator is visible in the first zone instead of the second display indicator.

In a particular embodiment of the invention, the second moving indicator can be at least partially superimposed on the first moving indicator to represent a partial eclipse of the first luminary, or even a total eclipse of the first luminary, when the second moving indicator completely covers the first indicator.

In a particular embodiment of the invention, the visible feature of the third indicator that differs is the diameter, which is preferably smaller than that of the second indicator.

In a particular embodiment of the invention, the third indicator can be superimposed on the first indicator to represent an annular eclipse of the Sun.

According to a particular embodiment of the invention, the display mechanism comprises a fourth moving indicator corresponding to the second luminary in a configuration that is different from those of the second indicator and of the third indicator, the fourth indicator having at least one visible feature that is different from the second indicator and from the third indicator.

In a particular embodiment of the invention, the feature of the fourth indicator that differs from the second indicator is its colour, which is preferably red in order to represent a lunar eclipse.

In a particular embodiment of the invention, the fourth indicator is visible in the first zone instead of the second indicator and/or the third indicator.

In a particular embodiment of the invention, the moving indicators are rotatable about the same axis of rotation.

According to a particular embodiment of the invention, the second indicator also has the function of representing the phases of the Moon, depending on its position relative to the cover.

In a particular embodiment of the invention, the first and second zone have shapes corresponding to conventional Moon phase display mechanisms.

According to a particular embodiment of the invention, the display mechanism comprises an electromechanical system configured to operate the display mechanism, the electromechanical system comprising a motor, a motor control unit, and a memory unit for storing dates and locations of lunar and solar eclipses, the control unit being configured to operate the motor depending on the dates and locations of the eclipses stored in the memory unit.

According to a particular embodiment of the invention, the electromechanical system comprises adjustment means configured to provide indications to the control unit allowing it to determine the occurrence of eclipses according to the location of a wearer of the horological movement.

In a particular embodiment of the invention, the adjustment means can be operated either electronically or by a mechanical adjustment.

The present invention further relates to a horological movement comprising a display mechanism according to the present invention.

### BRIEF DESCRIPTION OF THE FIGURES

The purposes, advantages and features of the invention will be understood upon reading the following detailed description given with reference to the accompanying drawings, in which:

FIG. 1 diagrammatically shows a top view of a display mechanism according to the invention, in the position for displaying the phases of the Moon,

FIG. 2 diagrammatically shows a top view of the display mechanism in FIG. 1, in the position for displaying a total eclipse of the Sun,

FIG. 3 diagrammatically shows a top view of the display mechanism in FIG. 1, in the position for displaying a partial eclipse of the Sun,

FIG. 4 diagrammatically shows a top view of the display mechanism in FIG. 1, in the position for displaying an annular eclipse of the Sun,

FIG. 5 diagrammatically shows a top view of the display mechanism in FIG. 1, in the position for displaying a total eclipse of the Moon,

FIG. 6 diagrammatically shows a top view of the display mechanism in FIG. 1, in the position for displaying a partial eclipse of the Moon, and

FIG. 7 shows a block diagram of an electromechanical system configured to operate the display mechanism of FIG. 1.

### DETAILED DESCRIPTION OF THE INVENTION

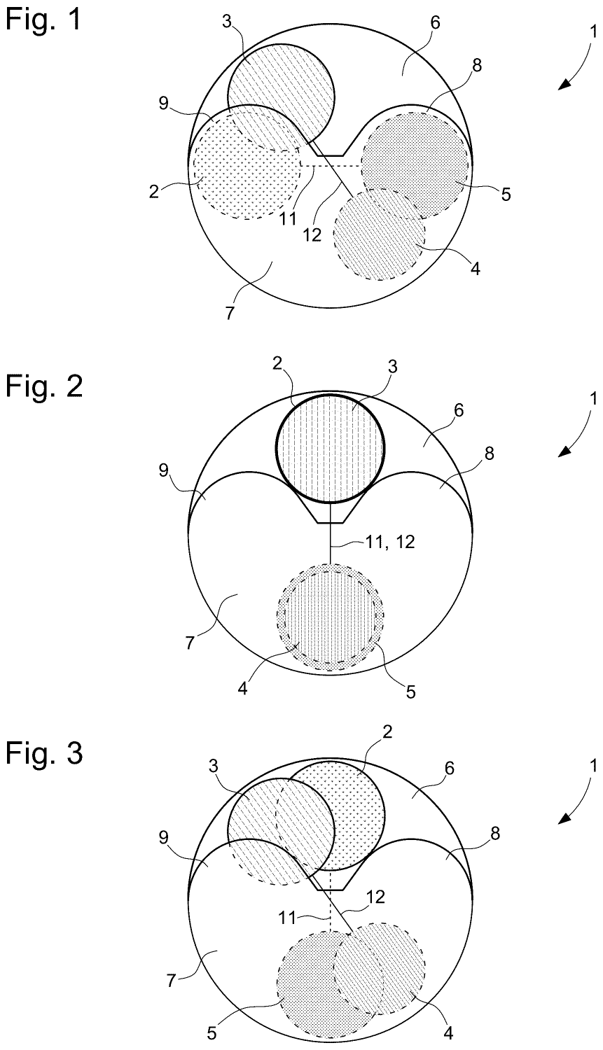

FIGS. 1 to 6 diagrammatically show a display mechanism for a mechanical or electromechanical horological movement configured to operate said mechanism. Preferably, the movement is electromechanical.

The display mechanism 1 comprises a first moving indicator 2 corresponding to a first luminary, for example the Sun, and a second moving indicator 3 corresponding to a second luminary, for example the Moon.

Additionally, the display mechanism 1 comprises a third moving indicator 4 and a fourth moving indicator 5, each of which also corresponds to the second luminary. However, the luminary is in a different visible configuration to that of the second indicator 3.

Thus, the third moving indicator 4 and fourth moving indicator 5 each have at least one feature that is different from the second moving indicator 3. Moreover, the fourth moving indicator 5 corresponds to the second luminary in a different configuration from both the second moving indicator 3 and the third moving indicator 4.

In this embodiment, the feature of the third indicator 4 that differs is the diameter, which is preferably smaller than that of the second indicator 3, in order to be able to represent an annular solar eclipse. The feature of the fourth indicator 5 that differs is its colour, which is preferably red to represent a lunar eclipse.

The moving indicators 2, 3, 4, 5 are disc-shaped in this case, and have substantially the same dimensions, except for the third indicator 4, which is smaller. Preferably, the first indicator 2 is yellow to represent the Sun, and the second indicator 3 is pink or grey to represent the Moon.

The four moving indicators 2, 3, 4, 5 are rotatable about the same axis of rotation. Each moving indicator is arranged at the end of an arm 11, 12 mounted on a rotary shaft, so that they can be operated independently of each other.

Preferably, the first indicator 2 and fourth indicator 5 are arranged at the ends of the same arm 11, as are the second moving indicator 3 and third moving indicator 4, which are arranged at the ends of another arm 12.

In an alternative embodiment, each moving indicator 2, 3, 4, 5 has a different arm, which can be operated independently of the arms of the other moving indicators.

The eclipse display mechanism 1 comprises a first zone 6 in which the indicators 2, 3, 4, 5 are visible, and a second zone 7 allowing the one or more indicators 2, 3, 4, 5 to be concealed behind a cover 7. The shapes of the first zone 6 and second zone correspond to conventional moon phase display mechanisms 1. Thus, the two zones together form a circular disc divided into two parts, the cover 7 having a half-disc shape increased by two half-discs 8, 9 with a diameter smaller than the radius of the circular disc of the two zones. The two half-discs 8, 9 extend towards the visible zone. The half-discs 8, 9 allow the phases of the Moon to be displayed thanks to the second indicator 3, in the conventional way.

The second moving indicator 3 can be at least partially superimposed on the first moving indicator 2 to represent a partial eclipse of the first luminary, with the second moving indicator 3 capable of being entirely superimposed on the first indicator 2 to represent a total eclipse of the first luminary.

The moving indicators 2, 3, 4, 5 are only visible when they are located in the first zone 6, and are concealed by the cover 7 when they are in the second zone.

The second moving indicator 3 can be superimposed over the first indicator 2 to represent the solar eclipse.

The second indicator 3 also has the function of displaying the phases of the Moon. Thus, in FIG. 1, when the Moon phases are displayed, the second moving indicator 3 moves into the visible zone 6, and the half-discs 8, 9 of the cover 7 allow part of the second moving indicator 3 to disappear to represent the visible part of the Moon.

The other moving indicators 2, 4, 5 are concealed by the cover in the second zone when there is no eclipse.

As a result of the common second arm 12 in one of the alternative embodiments, when the second indicator 3 moves, the third moving indicator 4 also moves, but remains concealed under the cover 7.

In FIG. 2, to show a total eclipse of the Sun, the first indicator 2 is positioned in the middle of the first visible zone 6, whereas the second indicator 3 is superimposed above the first moving indicator 2. Thus, the Moon overlaps and is centred on the Sun in order to represent a total eclipse of the Sun.

For a partial eclipse of the Sun, as shown in FIG. 3, the second indicator 3 is superimposed over only part of the first indicator 2. Thus, it can be seen that the first indicator 2 has a visible part, to show that the eclipse is only partial. The third and fourth indicator 4, 5 remain concealed behind the cover 7.

In the case of an annular eclipse of the Sun, in which a peripheral ring of the Sun always remains visible, it is the third moving indicator 4 which is superimposed above the first moving indicator 2 in the first visible zone 6, as shown in FIG. 3. The second moving indicator 3 and fourth moving indicator 5 are held in the second zone, behind the cover 7. In this embodiment, the second moving indicator 3 and third moving indicator 4 are also superimposed. As the third moving indicator 4 has a smaller diameter than the first indicator 2, a peripheral ring of the first indicator 2 remains visible to represent the visible ring 17 of the Sun.

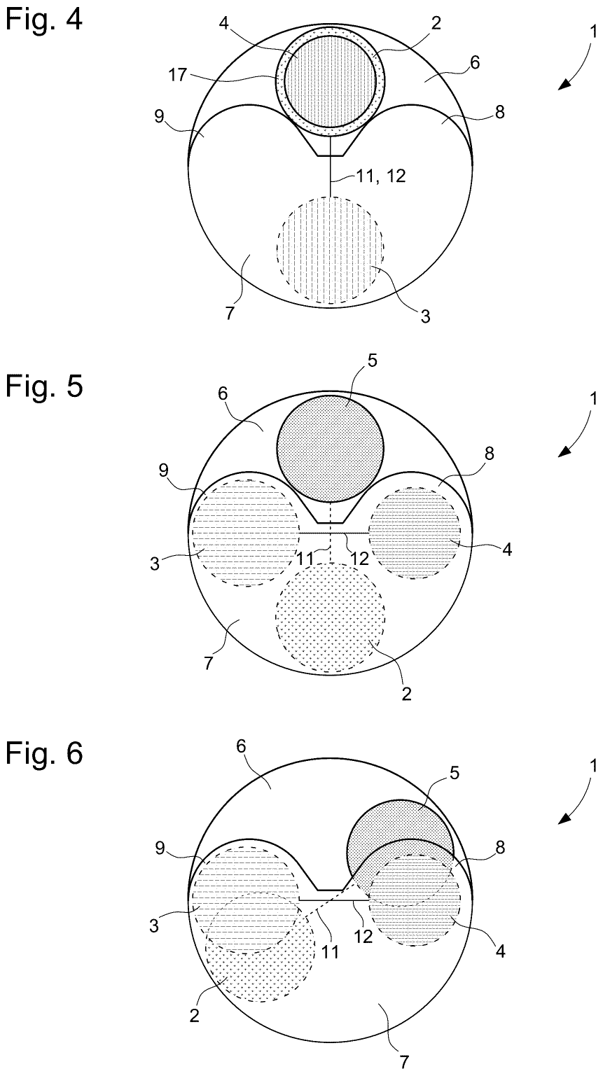

FIG. 4 shows an arrangement of the display mechanism 1 for a total lunar eclipse. The fourth moving indicator 5 is positioned alone in the middle of the first visible zone 6. The red colour of the fourth moving indicator 5 represents this total eclipse of the Moon. The other three moving indicators 2, 3, 4 remain concealed under the cover 7 in the second zone.

When the lunar eclipse is only partial, the fourth moving indicator 5 is positioned astride the two zones, so as to show a visible portion and keep another portion concealed under the cover 7 of the second zone, as shown in FIG. 5. Thus, since only part of the “red” Moon appears, it is understood that the lunar eclipse is only partial.

The invention further relates to an electromechanical device 10 for a horological movement, the electromechanical device 10 being configured to operate the display mechanism 1 described above.

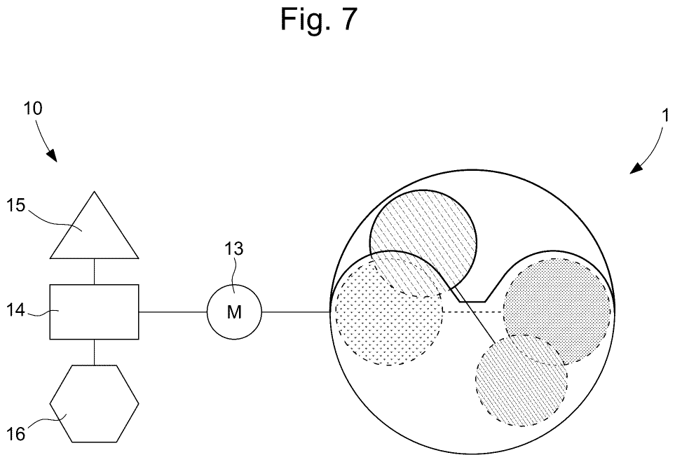

Such an electromechanical device 10 comprises an electronic part and a mechanical part known to a person skilled in the art. FIG. 7 shows a block diagram of such an electromechanical device 10.

The electromechanical device 10 comprises a motor 13 capable of operating the arms of the display mechanism 1, and further comprises a control unit 14 for the motor 13, configured to give operating commands to the motor 13. The control unit 14 is connected to the motor 13.

The electromechanical device 10 further comprises a memory unit 15 for storing the dates and locations of lunar and solar eclipses. The control unit 14 is connected to the memory unit 15, so that it can detect the upcoming occurrence of an eclipse. Such a memory unit 15 can store a large number of eclipse dates, locations and durations.

Thus, when the electromechanical device 10 detects that a lunar or solar eclipse is going to occur in a given location, based on the data in the memory unit 15, it instructs the motor 13 to arrange the one or more corresponding moving indicators into a position corresponding to said eclipse during the occurrence of said eclipse.

Preferably, the electromechanical device 10 comprises adjustment means 16 for providing indications to the control unit 14 allowing it to determine the occurrence of eclipses depending on the location of a wearer of the horological movement. In particular, the location of the wearer must be indicated in order to determine the dates, times and types of eclipse that occur.

Moreover, the adjustment means 16 can be operated either electronically or by a mechanical adjustment. For example, electronically, directly on the screen of the timepiece, by means of a drop-down menu appearing on the screen, or by wireless transmission means, for example from a mobile phone, or by mechanical adjustment, for example by positioning an engraved bezel of a timepiece.

The information required to display eclipses corresponding to the user's position can therefore be provided.

Such a display mechanism is arranged in a horological movement of a timepiece, such as a watch.

1. A mechanism for displaying lunar and solar eclipses for a mechanical or electromechanical horological movement configured to be able to operate said mechanism, the eclipse display mechanism (1) comprising a first moving indicator (2) corresponding to a first luminary, and a second moving indicator (3) corresponding to a second luminary, the eclipse display mechanism (1) comprising a first zone (6) in which the first indicator (2) and second indicator (3) are visible, and a second zone (7) allowing the one or more indicators (2, 3, 4, 5) to be concealed behind a cover (8), the eclipse display mechanism (1) comprising a third moving indicator (4) corresponding to the second luminary in a configuration that is different from that of the second indicator (3), the third moving indicator (4) having at least one visible feature that is different from the second moving indicator (3), the first indicator (2), the second indicator (3) and the third indicator (4) being disc-shaped, wherein the third indicator (4) is visible in the first zone (6) instead of the second indicator (3).

2. The display mechanism according to claim 1, wherein the second moving indicator (3) can be at least partially superimposed on the first moving indicator (2) to represent a partial eclipse of the first luminary, or even a total eclipse of the first luminary, when the second moving indicator (3) completely covers the first indicator (2).

3. The display mechanism according to claim 1, wherein the visible feature of the third indicator (4) that differs is the diameter, which is preferably smaller than that of the second indicator (3).

4. The display mechanism according to claim 3, wherein the third indicator (4) can be superimposed on the first indicator (2) to represent an annular solar eclipse.

5. The display mechanism according to claim 1, further comprising a fourth moving indicator (5) corresponding to the second luminary in a configuration that is different from those of the second indicator (3) and of the third indicator (4), the fourth indicator (5) having at least one visible feature that is different from the second indicator (3) and from the third indicator (4).

6. The display mechanism according to claim 5, wherein the feature of the fourth indicator (5) that differs is its colour, which is preferably red to represent a lunar eclipse.

7. The display mechanism according to claim 1, wherein the fourth indicator (5) is visible in the first zone (6) instead of the second indicator (3) and/or the third indicator (4).

8. The display mechanism according to claim 1, wherein the moving indicators (2, 3, 4, 5) are rotatable about the same axis of rotation.

9. The display mechanism according to claim 1, wherein the second indicator (3) also has the function of representing the phases of the Moon, depending on its position relative to the cover (7).

10. The display mechanism according to claim 1, wherein the shapes of the first zone (6) and second zone (7) correspond to conventional moon phase display mechanisms.

11. The display mechanism according to claim 1, further comprising an electromechanical system (10) configured to operate the display mechanism (1), the electromechanical system (10) comprising a motor (13), a control unit (14) for controlling the motor (13), and a memory unit (15) for storing dates and locations of lunar and solar eclipses, the control unit (14) being configured to operate the motor (13) depending on the dates and locations of the eclipses stored in the memory unit (15).

12. The display mechanism according to claim 11, wherein the electromechanical system (10) comprises adjustment means (16) configured to provide indications to the control unit (14) allowing it to determine the occurrence of eclipses according to the location of a wearer of the horological movement.

13. The display mechanism according to claim 12, wherein the adjustment means (16) can be operated either electronically or by a mechanical adjustment.

14. A horological movement, comprising the display mechanism (1) according to claim 1.
